(19) United States
(12) Patent Application Publication
(10) Pub. No.: US 2009/0206758 A1
(43) Pub. Date: Aug. 20, 2009

(54) Illumination Device, Illumination Control Apparatus, Illumination System

(75) Inventor: Sigmund Kobilke, Ingolstadt (DE)

Correspondence Address: PERMAN & GREEN, 425 POST ROAD, FAIRFIELD, CT, 06824, US

(73) Assignee: PERKINELMER ELCOS GMBH, Pfaffenhofen (DE)

(21) Appl. No.: 12/158,161

(22) PCT Filed: Dec. 20, 2006
(86) PCT No.: PCT/EP2006/012315

§ 371 Date: Jun. 19, 2008

(30) Foreign Application Priority Data
Dec. 21, 2005 (DE) 102005061204.0
Dec. 20, 2006 (EP) PCT/EP2006/012315

(51) Int. Cl. H01J 13/32; F21V 9/00; H05B 37/02; F21V 1/00

(52) U.S. Cl. 315/113; 362/231; 315/294; 362/235

(57) ABSTRACT

An illumination device comprises on a common substrate (10) at least one LED (11) of a first color, preferably blue, at least one LED (12) of a second color, preferably red, and preferably at least one LED (13) of a third color, preferably green, and at least one white LED (14). An illumination control apparatus (8) for an illumination device (1) comprises differing controllable power sources (83) for LEDs of differing colors for producing independently controlled operation signals for said LEDs of differing colors, differing output terminals (84) for the LEDs of differing colors for supplying the independently controlled operation signals to said LEDs of differing colors, and a first control means (81) for generating operation control signals for the controllable power sources. An illumination system comprising one or more above-mentioned illumination devices and one or more above-mentioned illumination control apparatuses.

### TECHNICAL FIELD OF THE INVENTION

The present invention relates to an illumination device, an illumination control apparatus, and to an illumination system as claimed in the independent claims.

An increasing number of applications require illumination devices of variable light color that are small in size but high in intensity and good in color variability and controllability. Light emitting diodes (LEDs) are increasingly used for illumination devices and systems. In former times, they have typically been used as indicator lights, but have not been used for projection or illumination systems because LEDs typically lack the required intensity. Nevertheless, LEDs are desirable light sources for many applications due to their small size, low costs, and ease of use. Another problem with LEDs is that they typically are not able to produce a high quality color spectrum. White LED light is produced by either using a blue LED or a UV LED with a phosphorous conversion layer. Such a conversion layer absorbs light from the blue or UV LED and reemits predominantly yellow and also red light components so that the superposition of transmitted light and reemitted yellow and red light renders the impression of white light. Here, the colour is not controllable because the ratio between the various components (transmitted light, reemitted light) is not controllable.

It is further known to closely juxtapose LEDs of a plurality of colors, particularly a red, a green and a blue LED, in order to generate light close to white light by the superposition of the three individual colors. But the results achieved by such an arrangement are not in all cases satisfying. Often, there is a lack of intensity in the range of yellow radiation (around 580 nm wavelength). Besides, both color and intensity of light from a particular LED vary with temperature and service lifetime of the LED, wherein color and intensity of one LED may themselves be interdependent, so that a color mix that was initially or once acceptable may degrade over time or with changing intensity.

### SUMMARY OF THE INVENTION

It is the object of the present invention to provide an illumination device, an illumination control apparatus, and an illumination system capable of rendering high quality, controllable illumination with LEDs.

This object is accomplished in accordance with the features of the independent claims. Dependent claims are directed on preferred embodiments of the invention.

An illumination device comprises on a common substrate at least one LED of a first color, preferably blue, at least one LED of a second color, preferably red, and preferably at least one LED of a third color, preferably green. Further, it comprises on said substrate at least one LED of white color.

The device may further comprise a temperature sensor and/or a light intensity sensor.

An illumination control apparatus for an illumination device such as mentioned above comprises differing controllable power sources for LEDs of different colors for producing independently controlled operation signals (voltages or currents) for said LEDs of different colors, different output terminals for the LEDs of different colors, respectively, for supplying the independently controlled operation signals to said LEDs of different colors, and a first control means for generating individual operation control signals for the controllable power sources. The operation control signal may be generated also in accordance with a temperature signal and/or a light intensity signal, these signals preferably coming from the illumination device controlled by the control apparatus.

An illumination system comprises one or more illumination devices as mentioned above, and one or more illumination control apparatuses as mentioned above.

### BRIEF DESCRIPTION OF THE DRAWINGS

In the following, aspects and embodiments of the invention will be described with reference to the enclosed drawings, in which

FIG. 1 is a schematic representation of an illumination device,

FIG. 2 is a spectrum of the various light components generated in the device of FIG. 1,

FIG. 3 is an explosion view of the illumination device,

FIG. 4 is a perspective view of the illumination device,

FIG. 5 is a schematic representation of another illumination device,

FIG. 6 is a schematic representation of yet another illumination device,

FIG. 7 is a sectional view of an illumination device,

FIG. 8 is a schematic view of an illumination control apparatus,

FIG. 9 is the representation of control signals,

FIG. 10 is a plot showing the color coordinates in color space of the illumination device of FIG. 1,

FIG. 11 is a plot showing a typical beam pattern for the device of FIG. 1,

FIG. 12 is a plot showing the relative intensity by angular displacement of the device of FIG. 1.

### DETAILED DESCRIPTION OF THE INVENTION

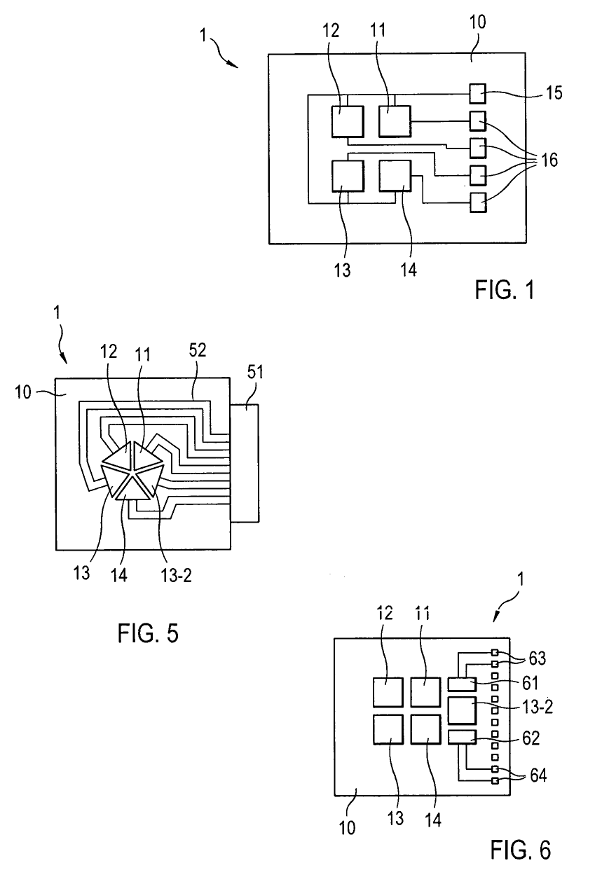

In the specification, same reference numerals will be used for same components and features. In FIG. 1, 1 symbolizes the illumination device, 10 a substrate, 11 a LED of a first color, preferably blue, 12 an LED of a second color, preferably red, 13 an LED of a third color, preferably green, and 14 an LED of white color. 15 and 16 symbolize connection means for the LEDs. These connection means are provided such that the LEDs are individually drivable. In the shown embodiment, the LEDs may have a common contact, for example a common cathode accessible through pad 15, and may have respectively own contacts of the polarity, in the given example individual anode contacts, shown as a plurality of pads 16 for the various colors. Accordingly, they are individually drivable.

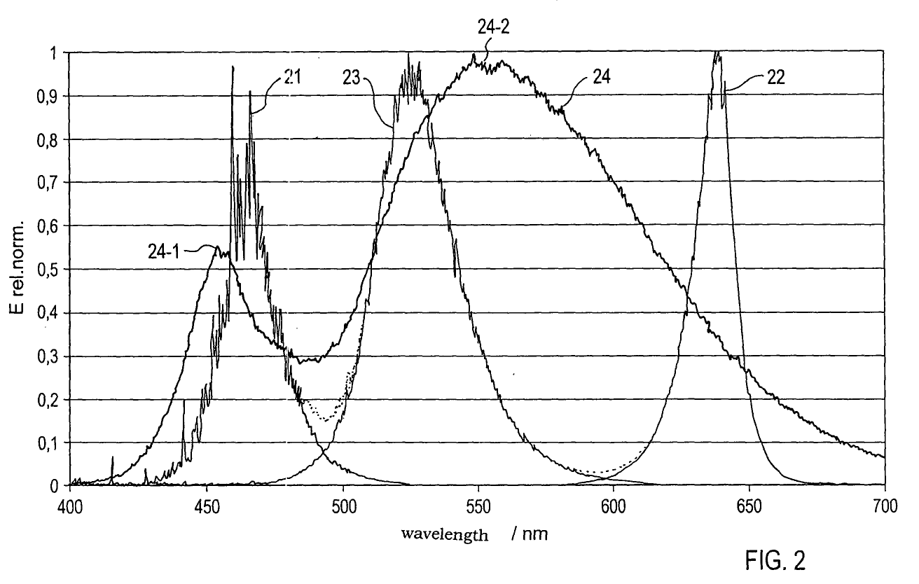

The spectrums of the various LEDs are shown in FIG. 2. 21 represents the intensity over wavelength from the blue LED 11. It may have a comparatively sharp maximum at a wavelength below 490 nm, preferably above 400 nm. 22 represents the intensity over wavelength of the red LED 12. It may have a comparatively sharp peak at a wavelength above 600 nm, preferably below 700 nm. 23 represents the output intensity of a green LED 13 with a comparatively sharp peak at a wavelength between 490 and 580 nm. 24 represents the output intensity of a white LED. A white LED may be formed by a blue or UV LED together with an associated light transformation means, this transformation means particularly comprising phosphor substances for absorbing the light from the blue or UV LED and reemitting it possibly over a wide range of the visible spectrum. The output spectrum of a white LED may have at least two global peaks, one in the range of blue or UV, the other in the range of green, yellow or red, preferably between 530 nm and 600 nm wavelength. In curve 24, peak 24-1 represents the intensity as generated and emitted by the basic blue or UV LED of the white LED and transmitted through the light transformation means. 24-2 represents the peak generated by the light absorbed from and reemitted by the light transformation means. It may be comparatively broad. The peak 24-2 is at a longer wavelength than peak 24-1, and may lie between the peak of the red curve 22 and the peak of the blue curve 21, preferably also between the red peak and the green peak of curve 23. Surprisingly, research of the inventors has shown that providing a white LED in addition to a blue and a red LED and possibly a green LED renders better results in controllability than adding a yellow LED to red, blue and possibly green. But a yellow LED may be provided in addition to a white LED.

In particular embodiments and depending on the control requirements, it may be possible to omit one of the color diodes, particularly the green LED 13, and hence use only a blue LED 11, a red LED 12, and a white LED 14. However, in other preferred embodiments, one or more of each of the blue, red, green and white LEDs are provided.

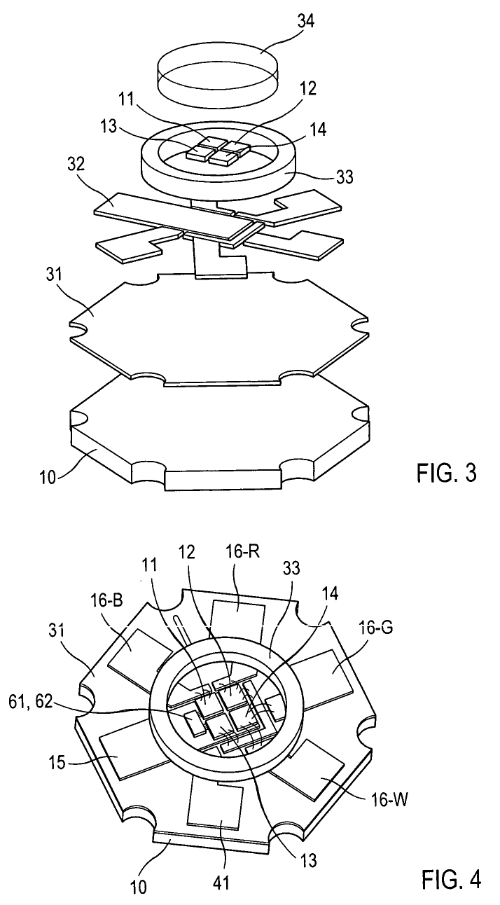

FIG. 3 shows an explosion view of a real construction of the illumination device. 11 to 14 symbolize the above-mentioned LEDs. They are arranged in close juxtaposition and preferably as close as their construction, wiring and other necessities allow this.

10 is a mechanical substrate of preferably good thermal conductivity. It may be or comprise a copper, e.g. as a plate of a desired thickness, such as one millimetre. 31 is an insulation layer of likewise good thermal conductivity. For better thermal conditions the insulation layer 31 could be partly removed and chips, especially with insulated backside, could be mounted directly on the substrate 10. In this case the insulation layer 31 contains the wiring for the back side contact of the red chip, the wire bond pads and the contact pads. 32 symbolizes a wiring pattern for contacting the LEDs such that they may be individually driven. 33 is an auxiliary body that may have retaining function for a cast substance 34, cast onto the mounted LEDs for protecting them and/or for converging light as described further down this specification.

FIG. 4 shows a perspective view of the arrangement in assembled state. 61 and 62 symbolize one or more sensors to be explained later. 15 and 16 symbolize as in FIG. 1 individual contacts for individual components. In the shown embodiment, 15 is, as in FIG. 1, a common cathode or alternatively anode. 16-B, 16-R, 16-G, and 16-W are anodes or alternatively cathodes for the blue, red, green, and white diode, respectively. 41 is a sensor contact.

The wiring pattern and contacting pattern may be different than that shown in FIG. 4. Instead of a common cathode, a common anode may be provided. Or both cathodes and anodes may be individually provided and accessible for each of the diodes in order to enhance controllability. Likewise, sensors 61, 62 may have individual contacts. The overall layout may be hexagonal or polygonal or circular or otherwise appropriately shaped, depending on constructional and other necessities.

FIG. 5 shows another schematic arrangement of an illumination device. Again, same reference numerals refer to same features. If 11 to 14 are the respectively mentioned LEDs. 13-2 may be a further LED of a color already provided. For example, the device may comprise two green LEDs 13 and 13-2. Generally speaking, one or more of the color LEDs (including the white LED) may be provided twice or a plurality of times. The LEDs of one color may be individually controllable or may be connected to each other, for example in series or in parallel to each other. As regards the physical arrangement, the LEDs of one color may be provided in a non-juxtaposed manner in order to render a good color mix.

The arrangement of FIG. 5 shows a pentagonal arrangement of the five LEDs. 52 are wirings from the LEDs to a connector 51 with an appropriate number of contacts. Again, LEDs may have a common cathode or a common anode, or may have individually accessible anodes and cathodes for each color or even for each diode of one color, depending on control requirements. The physical built of the embodiment of FIG. 5 may be similar to that shown in FIGS. 3 and 4, i.e. having a copper substrate, an insulating layer and thereon a wiring pattern connecting the LEDs and possibly provided sensors with the connector 51.

FIG. 6 shows a further illumination device. 11 to 14 are the already mentioned diodes. They are here arranged in a square array (2×2 LEDs). A possibly double provided LED 13-2 of one color may be set aside to the square arrangement. 61 symbolizes a temperature sensor for sensing the temperature of the substrate which closely follows the temperature of the LEDs. 62 is a light intensity sensor for sensing the intensity of light impinging on it. Sensor 62 may be a broad band sensor capable of sensing intensities across the spectrum as provided by the various LEDs. But likewise, a plurality of intensity sensors with sensitivities at a particular wavelength or wavelength range may be provided. The sensors 61, 62 may have corresponding contacting means, such as bonding pads 63, 64 or contact pins at a connector 51 as shown in FIG. 5.

The temperature sensor 61 may be provided as close as possible with the LEDs in order to sense the temperature as applying to the LEDs. The light intensity sensor 62 may be provided such that it receives a representative quantity of light from all LEDs. The light intensity sensor 62 may be or comprise a photo diode or a photo transistor. The temperature sensor may be a thermistor, a PTC (Positive Temperature Coefficient), a NTC (Negative Temperature Coefficient), or the like. One or both of these sensors produce signals that may be evaluated in a corresponding control for generating the drive signals for the respective LEDs also in accordance with temperature and/or sensed light intensity.

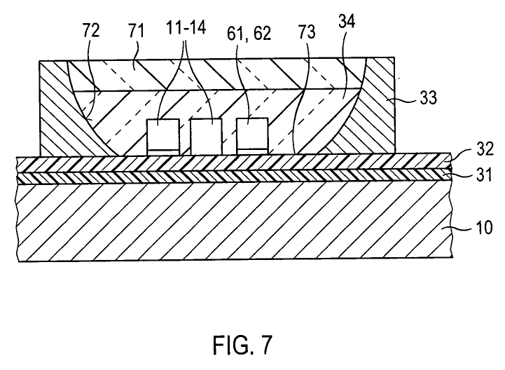

FIG. 7 is a schematic sectional view through an arrangement such as shown in FIG. 4. 11 to 14 symbolize the various LEDs. 61, 62 symbolize one or more of the sensors that may be provided. 34 is a more or less transparent protective cover for the various LEDs and possibly sensors. It may be a cast and curing substance. Connection of the LEDs and sensors to wiring on the substrate may be made through bonding so that thin bond wires may require mechanical protection. This can be accomplished by providing an initially liquid or semi-liquid and then hardening/curing, more or less transparent cover 34 for encapsulating the LEDs and their wiring, and possibly the sensors as provided. 33 is an auxiliary body that may have the function of retaining the protection 34 as long as it is liquid or semi-liquid. The auxiliary body may be ring-shaped and may of a material of good thermal conductivity. It may be glued to the accessible surface of the device. The inner surface 72 of the auxiliary body 33 may have concave portions and/or may form a concave structure together with the surface of the device. The angle between the surface 73 of the device and side wall 72 of the auxiliary body 33 may be obtuse. Through such a layout, the device obtains light converging properties.

71 may be a diffuser means. It may be another cast layer with light scattering properties. Light emitted from the LEDs is scattered back to the auxiliary body, to the LEDs, and to the surface 73 of the device. Side walls 72 of the auxiliary body 33 and device surface 73, respectively, may be reflecting or may have reflective portions. Then, light is again reflected preferably towards the outside. Through this, mixing of light is enhanced so that the impression of uniform white or colored light is given even when closely approaching the device 1.

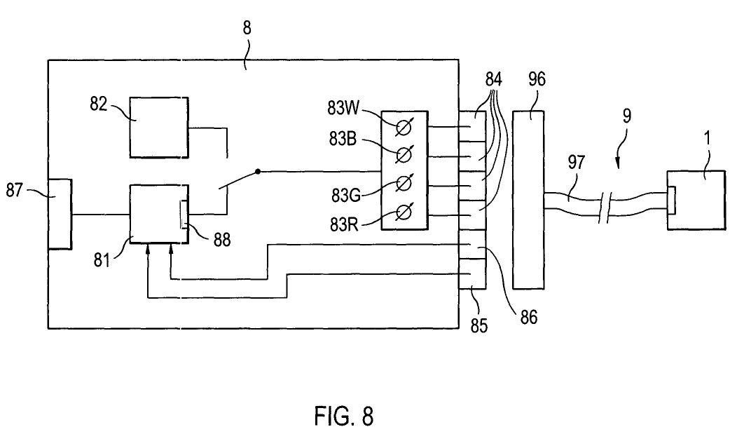

FIG. 8 shows a schematic view of an illumination control apparatus 8. It is adapted to be connected to an illumination device 1 through a connecting structure 9. The connecting structure 9 may comprise a multi-wire cable 97 and for example a connector 96, matching a corresponding connector on the side of the control apparatus. On the side of the illumination device 1, again a connector may be provided, or bonding pads or other appropriate connecting means. The illumination device 1 may be formed as described above.

The control apparatus 8 comprises a plurality of controllable power sources 83-R, 83-G, 83-B, 83-W for the respective diodes (red, green, blue, white) to be supplied with power on the side of the illumination device. The power sources generate the operation signals and may be controllable current sources producing controlled currents or controllable voltage sources producing controlled voltages. The controllable power sources 83 supply their operation signals (output current, output voltage) to a connector 84 from where it may be supplied to an illumination device 1 through connector 96 and cable 97.

The control apparatus further has a first control means 81 for generating operation control signals for the controllable power sources. Corresponding to the plurality of LEDs and the plurality of controllable power sources, a plurality of operation control signals is individually generated and supplied to the power sources, although FIG. 8 shows schematically only one signal line. The first control means 81 may be of more or less complex nature. It receives external illumination control quantities through a control input means 87. The input means may be some kind of automatic target value provision, and/or it may be or comprise manual settings through switches, potentiometers, or other appropriate input means for users. The first control means 81 may be of comparatively complex nature. It may have access to pre-stored characteristics of the LEDs and to pre-stored characteristics of light mixing properties. For example, look-up-tables for the respective intensities of the various LEDs and possibly interpolation means may be provided. Such tables may be accessible in dependence of a scale of target settings.

In a particular embodiment, the first controller may supply pulse width modulation signals (PWM signals) to the controllable power sources, respectively, through a PWM controller 88. This would have the effect that if switched on, the LEDs have a given, known intensity, and in driving the LEDs one will not run into the non-linearity between driving current and light intensity. But likewise, voltage amplitude or current amplitude may be controlled through the output of first control means 81.

The first control means 81 may also receive a temperature signal and/or a light intensity signal, these signals being referred to when preparing the operation control signals. The temperature signal and light intensity signal may be supplied through inputs 85 and 86, respectively. They may come directly from the illumination device 1 from the sensors 61, 62 provided there. These sensor signals may be compared with rated or previous values, and correction may for example take place in accordance with a deviation between a rated or previous value and the sensed value.

The control apparatus 8 may include a second controller 82. It may generate test control signals for the controllable power sources for generating test signals for said LEDs. The second controller 82 may operate intermittently with the first controller 81, symbolized through a switch in FIG. 8. In a practical embodiment, an appropriately programmed controller may be provided for rendering both the operation control signals and the test control signals in an alternating manner.

Generally speaking, test signals may be generated in a predetermined way, e.g. of predetermined voltage or current amplitude or pulse width. While the LEDs are driven by the test control signals, the light intensity of the LEDs is acquired through the intensity sensor 62 and fed to the first controller 81. There, the acquired value is used for generating the operation control signals after the test is over and usual operation is resumed. Through this technique, temperature dependencies and effects due to aging can be compensated.

The signal intensity acquired during the test mode may be compared with expected or rated or previous values, and in dependence of the comparison, readjustments of the respective drive values during operation control for generating the operation control signals are made. Particularly, either a voltage or current amplitude correction or a pulse width correction can be made, depending on the nature of the output of the first controller 81 and the power sources.

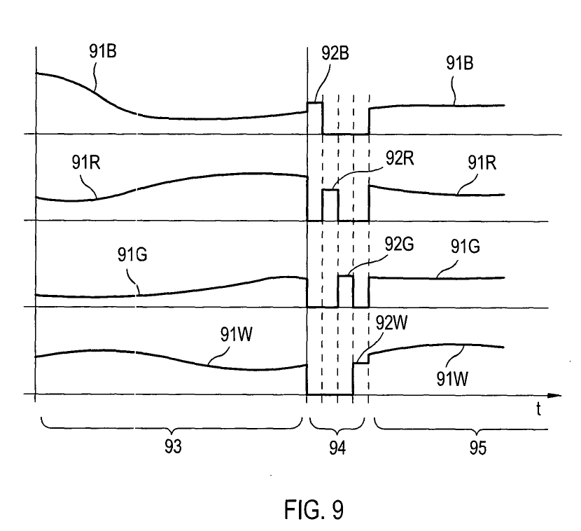

FIG. 9 shows a particular way of rendering control signals. 93 is a time period of usual operation. 94 is a test time period. 95 is a further time of usual operation. Another test time period 94 may follow thereafter, and so on. Test time periods may come periodically, for example once every minute, once every ten seconds, or the like. The test time periods themselves may be comparatively short, e.g. shorter than 200 ms. The LEDs themselves are comparatively fast devices with response times of less than 100 ns. Likewise, the optical sensors are comparatively fast with response times of less than 10 μs. In many cases, response times of the controllable power sources will be the limiting factor. Anyway, the test periods can be made such that the changed illumination due to the test signals are not visible for the human eye.

FIG. 9 shows an embodiment in which test signals 92B, 92R, 92G, and 92W are generated for the blue, red, green, and white LED, respectively. These test signals may have a predetermined current or voltage amplitude and/or a predetermined pulse width for driving the respective diode correspondingly. In a preferred way, during test only one LED (or LEDs of one color) are driven at a time, whereas the other LEDs (the LEDs of the other colors) are switched off. Then, the intensity sensor senses only the intensity of one color, and a respective color intensity signal can be acquired. Through this, correction values for all colors including white can be acquired and can be individually used for the respective color components when generating operation control signals for the usual operation in time period 93 and 95.

FIG. 9 shows the test control signals for the various colors being generated immediately one after another. However, in order to shorten the duration of the test time period 94, they may be generated one by one or for only some, not all of the LEDs intermittently with the usual operation, for example after a time of usual operation a test signal 92B for the blue diode is generated, then again usual operation is resumed, then a test signal 92R for the red diode is generated, then usual operation is continued, and so on. Corresponding to the generation of the test signals for the various colors, the various light intensities are acquired and processed separately for the individual colors. The acquired values may be compared with respective rated or earlier values in order to determining respective correction values for the individual colors. Such correction values may be stored and used further on for generating operation control signals.

The control apparatus 8 may comprise a digital controller including computer components such as CPU, RAM, ROM, respective interfaces, a bus, and the like. But it may also be an ASIC (Application Specific Integrated Circuit) having access to particular characteristics, tables or the like. In one embodiment, the control apparatus 8 may be formed on the same substrate as the illumination device 1 and receive illumination target values from external sources.

Together with an illumination device 1 as described above, the controller 8 forms an illumination system.

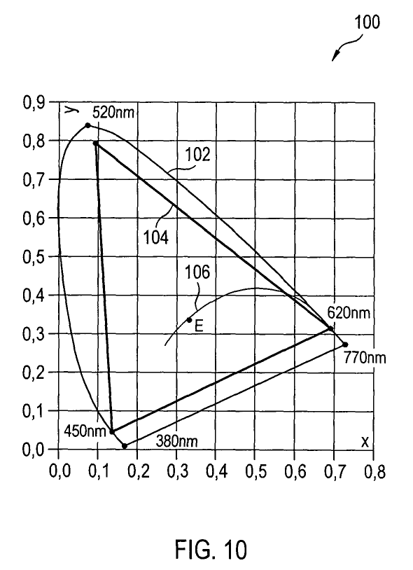

Illumination devices and systems as described above are capable of producing a high quality controllable light that cannot be obtained with a standard RGB device. The LEDs can be selected based on factors such as wavelength and intensity. Using this distribution, along with two green LEDs, such a device can cover more than 85% of the visible color space 100, such as is shown in FIG. 10. The outer elliptical shape 102 represents all visible wavelengths, while the inner triangular shape 104 represents the colors that can be produced using a device such as described with respect to FIG. 1. The curved line 106 in the middle is referred to as a “white line,” as the line represents all the combinations of the LEDs at all the various color temperatures that combine to produce white light. A good “sunlight” white can be obtained with a color temperature in a range around 5000-6000K.

Such a device can allow similar currents to be applied to each of these state-of-the-art LED chips. The device also can operate at a relatively high power to produce high intensity light. The placement and use of the anode and cathode pads allow a user to easily apply and vary a desirable amount of current to each LED to obtain the desired illumination.

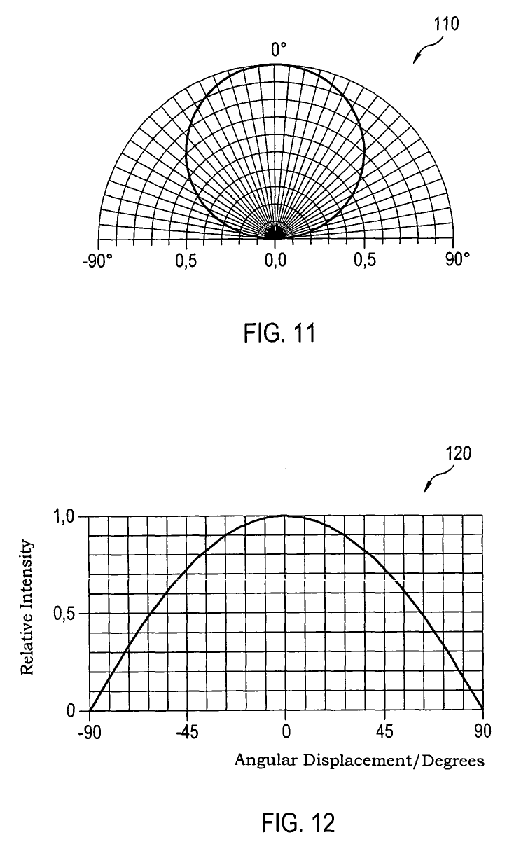

Such a device also can tend to generate light in a fairly non-concentrated manner. A device in accordance with one embodiments is a Lambertian emitter with a 120° aperture. For instance, FIG. 11 shows a typical beam pattern 110 and FIG. 12 shows relative intensity 120 by angular displacement for a device such as is described with respect to FIG. 1. For various applications, such as projection, where it is desired to have a more focused beam of light produced, a number of optical elements can be used to adjust the output of the illumination device. Any of a number of optical elements known or used in the art can be positioned to collimate, focus, direct, filter, or otherwise modify the output of the device.

1. An illumination device (1), comprising on a common substrate (10)
at least one LED (11) of a first color, preferably blue,
at least one LED (12) of a second color, preferably red, and preferably at least one LED (13) of a third color, preferably green,
characterized in comprising
at least one white LED (14) on said common substrate.

2. The device according to claim 1, characterized in that the white LED (14) is formed by a blue or UV LED and an associated light transformation means.

3. The device according to one or more of the preceding claims, characterized in further comprising a temperature sensor (63), preferably arranged on said common substrate.

4. The device according to one or more of the preceding claims, characterized in further comprising a light intensity sensor (64), preferably arranged on said common substrate.

5. The device according to one or more of the preceding claims, characterized in further comprising a diffuser means (71) above a plurality of said LEDs.

6. The device according to claim 5, characterized in that the diffuser means is formed on a transparent cover (34) covering a plurality of LEDs.

7. The device according to claim 5 or 6, characterized in that the substrate comprises a reflective region (73).

8. The device according to one or more of the preceding claims, characterized in that LEDs of differing colors have differing anode contacts (15) and/or differing cathode contacts (16).

9. The device according to one or more of the preceding claims, characterized in that it is adapted for pulse width modulating operation, current control operation or voltage control operation.

10. The device according to one or more of the preceding claims, characterized in comprising a light converging portion (72), preferably a concave reflector, further preferably a reflecting and concave portion of the substrate and/or of an auxiliary body (33).

11. The device according to one or more of the preceding claims, characterized in comprising two or more LEDs (11, 11-2) of the same color including white.

12. The device according to one or more of the preceding claims, characterized in that two or more LEDs of the same color are arranged in a non-adjacent manner.

13. An illumination control apparatus (8) for an illumination device (1), the illumination device comprising a plurality of LEDs (11-14) of differing colors and preferably being built according to one or more of the preceding claims,
characterized in comprising
differing controllable power sources (83) for LEDs of differing colors for producing independently controlled operation signals for said LEDs of differing colors,
differing output terminals (84) for the LEDs of differing colors for supplying the independently controlled operation signals to said LEDs of differing colors, and
a first control means (81) for generating operation control signals for the controllable power sources.

14. The apparatus of claim 13, characterized in comprising an input terminal (85) for a temperature signal, wherein the first control means generates the operation control signals in accordance with the temperature signal.

15. The apparatus of claim 13, characterized in comprising an input terminal (86) for a light intensity signal, wherein the first control means generates the operation control signals in accordance with the light intensity signal.

16. The apparatus according to one or more of the claims 13 to 15, characterized in further comprising a second control means (82) for generating test control signals for the controllable power sources for generating test signals for said LEDs.

17. The apparatus according to claim 16, wherein the test control signals and test signals are generated and supplied intermittently with said operation control signals and operation signals.

18. The apparatus according to claims 15 and 17, characterized in that the second control means generates the test control signals such that the test signal for the LEDs of at least one color is reduced or switched off, wherein the first control means acquires the light intensity signal while said LED of at least one color receives the reduced or switched-off signal, and uses said acquired light intensity for generating said operation control signals.

19. The apparatus according to claim 18, characterized in that the second control means generates the test control signals such that successively the test signal for the LEDs of all colors are reduced or switched off, wherein the first control means acquires successively the respective light intensity signals, and uses said successively acquired light intensities for generating said operation control signals.

20. The apparatus according to one or more of the claims 13 to 19, characterized in comprising a control input means (87) for inputting an external illumination control quantity, wherein the first control means generates the operation control signals in accordance with the external illumination control quantity.

21. The apparatus according to one or more of the claims 13 to 20, characterized in that the control means comprises a pulse width modulation controller (88).

22. An illumination system comprising one or more illumination devices according to one or more of the claims 1 to 12 and one or more illumination control apparatuses according to one or more of the claims 13 to 21.
